(19) United States
(12) Patent Application Publication
(10) Pub. No.: US 2021/0235171 A1
(43) Pub. Date: Jul. 29, 2021

(54) REAL-TIME OPERATIONS INFORMATION ON WEARABLE SMART HEADS UP DISPLAY

(71) Applicant: Halliburton Energy Services, Inc., Houston, TX (US)

(72) Inventors: Derek J. Abel, Duncan, OK (US); Stanley C. Combs, Comanche, OK (US); Craig A. Sneed, Duncan, OK (US)

(21) Appl. No.: 17/053,025

(22) PCT Filed: Nov. 28, 2018
(86) PCT No.: PCT/US2018/062721

§ 371 Date: Nov. 4, 2020

Related U.S. Application Data
(60) Provisional application No. 62/682,408, filed on Jun. 8, 2018.
(60) Provisional application No. 62/682,391, filed on Jun. 8, 2018.
(60) Provisional application No. 62/682,341, filed on Jun. 8, 2018.
(60) Provisional application No. 62/682,358, filed on Jun. 8, 2018.
(60) Provisional application No. 62/682,374, filed on Jun. 8, 2018.

(51) Int. Cl. H04Q 9/00; G05B 15/02; G06F 16/245; G06Q 10/06; G06Q 10/00; G06Q 50/02; G06F 3/14; E21B 41/00; G08B 7/06; H04L 29/08

(52) U.S. Cl. CPC H04Q 9/00; G05B 15/02; G06F 16/245; G06Q 10/0635; G06Q 10/20; H04L 67/12; G06Q 50/02; G06F 3/14; E21B 41/00; G08B 7/06; G06Q 10/06313

(57) ABSTRACT

To reduce costs and free on-site personnel to freely move about a well site in a hydrocarbon recovery, exploration, operation, or services environment, systems and methods are presented for collecting data associated with one or more on-site pieces of equipment, distributing the collected data using a network system, optionally storing the collected data in one or more resources including databases, and producing a notification on a wearable notification device based, at least in part, on the collected data to enable on-site users to respond to the collected data by modifying on-site operations.

### TECHNICAL FIELD

The present disclosure relates generally to the use of notification devices at a hydrocarbon recovery, exploration, operation, or services environment and, more particularly, to wearable smart heads-up display devices that enable real-time notification regarding one or more drilling operations from a remote location for a hydrocarbon recovery, exploration, operation, or services environment.

### BACKGROUND

A hydrocarbon recovery, exploration, operation, or services environment will typically include multiple systems and operations. These systems and operations may produce a great deal of information that oil field operators may be tasked with tracking. Oil field workers may be tasked with monitoring this information to improve oil production and identify and report risky circumstances, which might require viewing information on one or more displays at a workstation in a fixed location. Additionally, oil field operators may be tasked with interacting with these systems and operations which may require operators to leave the fixed location.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a diagram of a well site notification system, according to one or more aspects of the present disclosure.

FIG. 2 is a flow diagram of a method for providing notifications, according to one or more aspects of the present disclosure.

FIG. 3 is an image of an exemplary wearable notification device, according to one or more aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present disclosure relates generally to the use of notification devices at a hydrocarbon recovery, exploration, operation, or services environment. The present disclosure relates more particularly to wearable smart heads-up display devices that enable real-time notification regarding one or more operations occurring at a hydrocarbon recovery, exploration, operation, or services environment.

Illustrative embodiments of the present disclosure are described in detail herein. In the interest of clarity, not all features of an actual implementation are described in this specification. It will, of course, be appreciated that in the development of any such actual embodiment, numerous implementation-specific decisions must be made to achieve developers' specific goals, such as compliance with system-related and business-related constraints, which will vary from one implementation to another. Moreover, it will be appreciated that such a development effort might be complex and time consuming but would nevertheless be a routine undertaking for those of ordinary skill in the art having the benefit of the present disclosure. Furthermore, in no way should the following examples be read to limit, or define, the scope of the disclosure.

Disclosed herein is a well site notification system comprising one or more sensors for collecting data associated with one or more well site equipment, wherein the one or more sensors is at a first location; a notification device at a second location; a network system coupled to the one or more sensors and the notification device; and a data repository, wherein the notification device may receive the data and provide one or more notifications based, at least in part, on the data, and wherein one or more operations of the one or more well site equipment may be modified based, at least in part, on the first one or more notifications.

In one or more embodiments, the notification device further may comprise one or more of a display system, an audio system, a haptic feedback system, and a communication system. In one or more embodiments, the one or more notifications may be one or more of one or more audio notifications, one or more visual notifications, and one or more haptic notifications. In one or more embodiments, the notification device may provide the one or more notifications in at least one of one or more augmented reality environments and one or more virtual reality environments. In one or more embodiments, the notification device may be at least one of a wearable device and a portable device.

In one or more embodiments, the data may be collected in real-time and the one or more notifications may be provided in real-time. In one or more embodiments, the notification device may further comprise a processor, and the processor may execute one or more instructions that at least one of requests the data from the data repository, receives the data from the data repository, and modifies the data to produce the notification based, at least in part, on the data from the data repository. In one or more embodiments, the first location may be in close proximity to the second location.

Disclosed herein is a method comprising collecting a first data associated with one or more equipment; storing the first data in a data repository; retrieving the first data from the data repository; transmitting the first data to a notification device; producing a first notification using the notification device based, at least in part, on the first data, and modifying one or more well site operations corresponding to the one or more equipment based, at least in part, on the notification produced using the notification device.

In one or more embodiments, the first notification may comprise one or more of a status indication, a warning notification, and a maintenance notification. In one or more embodiments, the first notification may comprise one or more of one or more audio notifications, one or more visual notifications, and one or more haptic notifications. In one or more embodiments, the method may further comprise requesting the first data from the data repository. In one or more embodiments, the method may further comprise periodically requesting the first data from the data repository and periodically updating the first notification. In one or more embodiments, the method may further comprise producing a second notification based, at least in part, on the first data, wherein the second notification eliminates the first notification. In one or more embodiments, transmitting the first data to the notification device may further comprise wirelessly transmitting the data. In one or more embodiments, the first data may be real-time data and the first notification may be produced in real-time.

In one or more embodiments, modifying one or more well site operations may further comprise one or more of modifying cementing operations, modifying drilling operations, modifying mud system parameters, modifying bulk material system parameters, mitigating well site operations risks, and modifying well site equipment for repairs and improvements. In one or more embodiments, the method may further comprise transmitting a second data to the notification device; and producing a second notification using the notification device based, at least in part, on the second data, wherein the second data corresponds to the first data.

Disclosed herein is a well site notification system comprising one or more sensors for collecting data associated with one or more well site equipment, wherein the one or more sensors is at a first location; a notification device at a second location; a network system coupled to the one or more sensors and the notification device; and a data repository, wherein the data repository stores the data, wherein the notification device receives the data and provides one or more notifications based, at least in part, on the data and based, at least in part, on at least one of one or more configuration settings and one or more access controls, and wherein one or more operations of the one or more well site equipment is modified based, at least in part, on the first one or more notifications.

In one or more embodiments, the notification device may further comprise one or more of a display system, an audio system, a haptic feedback system, and a communication system.

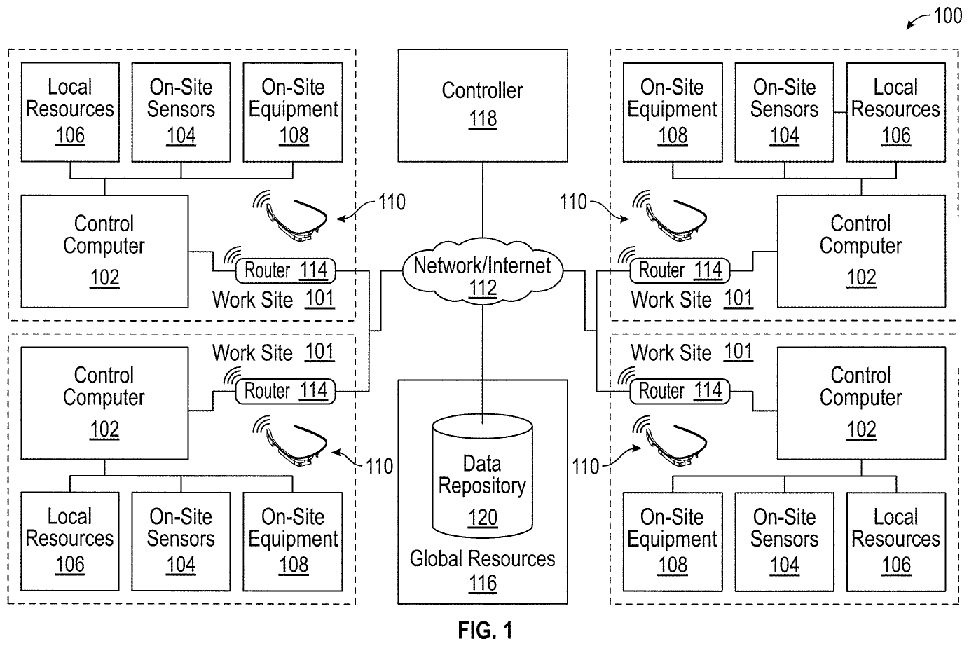

FIG. 1 is a diagram of a well site notification system, according to one or more aspects of the present disclosure. The well site notification system 100 may comprise one or more work sites 101. Work sites 101 may also be referred to herein as sub-sites. Work sites 101 may comprise one or more control computers 102, one or more pieces of on-site equipment 108, one or more on-site sensors 104, one or more local resources 106, one or more networking devices including routers 114, and one or more notification devices 110. Networking devices and routers 114 may be coupled to a network 112. Work sites 101 may be coupled, directly or indirectly via network 112, which may comprise one or more wired and wireless technologies. System 100 may further comprise controller 118 and resources 116.

On-site equipment 108 may include any and all equipment—whether physical (for example, drilling equipment, wireline tools, employee computers, gauges, meters, valves) or virtual (for example, software applications) that may enable hydrocarbon recovery, exploration, operation, or services. Although the system 100 may be deployed in any suitable context, this disclosure describes the system in the context of an oil and gas corporation. The system 100 is not limited to these examples.

In one or more embodiments, on-site equipment 108 may be coupled to one or more control computers 102. The one or more control computers 102 and the one or more notification devices 110 may be coupled to networking devices, including router 114. As noted above, router 114 may be coupled to network 112, such that control computers 102 and notification devices 110 are also coupled to network 112 via router 114. Control computer 102 may be coupled with one or more on-site sensors 104 and one or more local resources 106. Local resources 106 may comprise a local storage system such that the control computer 102 may store site information, and related data and information, in the local storage.

A work site 101 may further comprise one or more on-site sensors 104. In one or more embodiments, control computer 102 may periodically poll on-site sensors 104 for on-site data. In one or more embodiments, sensors 104 may be configured to continuously monitor the well site and on-site equipment to collect on-site data. On-site data may include without limitation volumes, levels, weights, temperatures, pressures, rates, densities, speeds, positions, torques, viscosities, conductivities, pH levels, valve positions, engine and motor information, and other data associated with any one or more systems, equipment, and devices at the well site or remote from the well site. On-site data may be provided to one or more devices, including without limitation local storage such as in local resources 106, remote storage such as data repository 120, and control computers 102. In one or more embodiments, a control computer 102 may provide on-site data to one or more notification devices 110. The one or more notification devices 110 may produce a notification based, at least in part, on the on-site data to enable a user or an operator at a work site 101 to respond based, at least in part, on the on-site data. In one or more embodiments, data from one or more sensors 104 may be real-time data. In one or more embodiments, a sensor 104 may be associated with a particular piece of equipment 108. For example, an on-site sensor 104 associated with a concrete operation may sense one or more slurry properties and provide the slurry property information to a control computer 102 for storage or distribution along network 112.

Network 112 may be any suitable computer network that enables multiple computing devices to communicate with each other. Network 112 may comprise, without limitation, the Internet, a virtual private network, a local area network, a wide area network, and any other such network or combination of networks. Network 112 may be a public network or a private/restricted network and may comprise a primary and secondary network that need not be the same type of network. Further, each work site 101 may comprise one or more networks which may be coupled together to form a larger network. In one or more embodiments, a work site 101 may be accessible for network communication at a single address (for example, an IP address). For example, a single IP address might enable simplified data collection and notification routing.

Network 112 may comprise any network topology, including without limitation wired and wireless solutions, direct and indirect coupling between nodes, local area networks (LANs), wide area networks (WANs), and low power WANs (LPWANs). Wireless communication methods may include without limitation wireless networks, infrared communication, microwave communication, radio, and satellite transmission. Additionally, wireless communication may occur through various data communication specifications including without limitation Wi-Fi, Bluetooth, long-term evolution (LTE), Worldwide Interoperability for Microwave Access (WiMax), or Zigbee. Such coupling may occur also through wired communication media including without limitation controller area network (CAN) buses, coaxial cable, fiber optic cable, and twisted pair cable. Communication between devices may occur using one or more communication protocols including without limitation Open Platform Communications Unified Architecture (OPC UA), Z-Wave, and user data protocol (UDP) and transmission control protocol (TCP) sockets. Certain standards, specifications, protocols, and architectures may be suitable for defining real-time data communication within the remote monitoring and control system including without limitation Ethernet for Control Automation Technology (EtherCAT), EtherNet/IP, Process Field Net (PROFINET), Ethernet Powerlink, Sercos III, CC-Link, and Modbus.

Resources 116 may be coupled to network 112. Resources may include without limitation wellbore data, drilling logs, well logs, geological data, geophysical data, historical data of all kinds, equipment data, databases, software applications, workflows, corporate policies and procedures, personnel data and directories, specific persons, and other data and data and information. Resources may be stored on various types of storage (for example, servers not specifically shown). Resources may be co-located at work sites 101 as local resources 106, may be located as global resources 116, or they may be distributed across various locations. Resources 116 may further comprise a database or data repository 120 for storing on-site data, received from the one or more work sites, along with related data and information, and for providing on-site data and related data and information to controller 118.

In one or more exemplary embodiments, controller 118 may be configured for security purposes. For example, controller 118 may limit or direct data flow between work sites 101 and global resources 116. In one or more embodiments, controller 118 may enable information processing, such as on-site data processing or notification implementation. For example, controller 118 may direct data to a user wearing a notification device 110 to provide a notification regarding a particular resource at a work site 101 in an unsafe state. Likewise, controller 118 may provide instructions, stored, for example, in local resources 106, to the operator including instructions regarding disabling the resource to avoid an accident. In response, the operator may modify operations based, at least in part, on notification regarding the unsafe condition. In one or more embodiments, controller 118 may limit distribution of on-site data based, at least in part, on one or more configuration settings and one or more access controls. For example, it may be beneficial to prevent distribution of on-site data to certain notification devices to prevent unnecessary notifications from interrupting or interfering with user performance on-site. It may also be beneficial to limit data distribution to prevent on-site data from being made available to users without proper security authorizations. In one or more embodiments, controller 118 may be configured to receive data from a work site 150 and transmit data corresponding to the data from the work site 150 to a remote site 160. For example, data from the work site 150 may be indicative of a dangerous condition and the controller 118 may transmit a warning indication to users at a remote site 160 based on receipt of the data indicative of the dangerous condition and enabling a response to the dangerous condition. In another example, data from the first sub-site may be provided to the controller 118 and data provided to the remote site 160 may indicate that access to the data from the work site 150 is not available to the remote site 160 based, at least in part, on a security setting. As one of ordinary skill will understand, software may be designed to enable the controller 118 to act appropriately within the context of the system 100 and the particular hydrocarbon recovery, exploration, operation, or services environment.

As described herein, control computers 102 (generally, computers) may comprise any suitable machine or network of machines capable of communicating with other network equipped devices including without limitation on-site equipment, notification devices, control devices, network devices, storage devices, and resources. Computers may comprise a processor or central processing unit configured for executing instructions, program instructions, process data, or any combination thereof. The processor may be configured to interpret and execute program instructions, software, or other data retrieved and stored in memory, including without limitation read-only memory (ROM), random access memory (RAM), solid state memory, or disk-based memory.

Modifications, additions, or omissions may be made to computers without departing from the scope of the present disclosure. Any suitable configurations of components may be used. For example, components of computers may be implemented either as physical or logical components. Furthermore, in one or more embodiments, functionality associated with computers may be implemented in special purpose circuits or components. In one or more embodiments, functionality associated with components of computers may be implemented in configurable general-purpose circuit or components, such as configured computer program instructions.

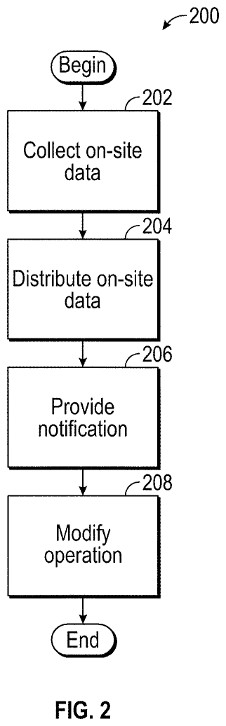

In any embodiment, computers may include a non-transitory computer readable medium that stores one or more instructions where the one or more instructions when executed cause the processor to perform certain actions. As used herein, a computer may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. FIG. 2 is a flow diagram of a method 200 for providing notifications, according to one or more aspects of the present disclosure. The method begins by collecting on-site data (step 202). On-site data may be collected by one or more on-site sensors 104 and may optionally be stored in one or more storage systems, including without limitation in local resources 106 and in global resources 116 including data repository 120. On-site data may be provided to one or more notification devices (step 204). The on-site data may be automatically distributed by on-site sensors 104, may be requested from data repository 120, for example, by control computer 102 for distribution to notification devices 110, or automatically provided to one or more notification devices 110. Data distribution may be handled by one or more of control computers 10, global resources 116 including data repository 120, and controller 118. A notification device 110 may receive on-site data and produce a notification to a user wearing the notification device 110 (step 206). In one or more embodiments, notifications may comprise a variety of notification types, including without limitation status notifications, warning notifications, maintenance notifications, and any combination thereof. In one or more embodiments, notifications may comprise one or more of an audio notification, a visual notification, a haptic notification, and any combination thereof. In one or more embodiments, providing a notification (step 206) may comprise evaluating on-site data and related data and information to determine if one or more notifications should be prioritized over one or more other notifications. The notification may prompt a reaction from the user. For example, a user may be prompted to modify operation of on-site equipment 108, systems, or resources to, for example, improve performance of one or more systems or operations on-site (step 208). In one or more embodiments, method 200 may be performed in real-time. As noted herein, modifying operation on-site (step 208) based, at least in part, on a notification may include without limitation modifying one or more of cementing operations, drilling operations, mud system controls and parameters, bulk material system controls and parameters, mitigating on-site operations risks, and modifying on-site equipment for repairs and improvements.

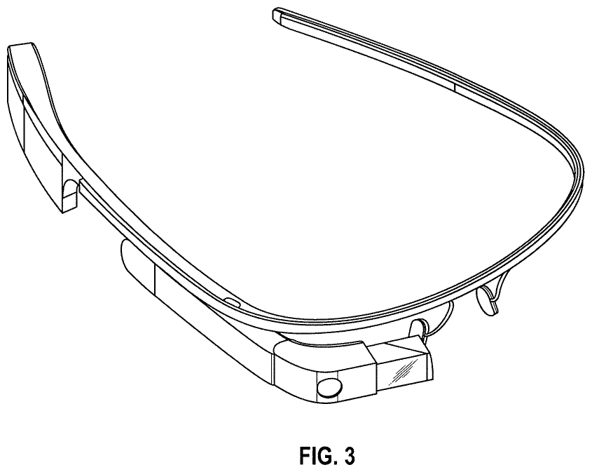

FIG. 3 is an image of an exemplary wearable notification device, according to one or more aspects of the present disclosure. The notification device may be an optical device or other personal device, smart or otherwise, that may be worn by a user on- and off-site. A user may comprise a person or individual, a subject matter expert, an operator, personnel, a system, any other type of user or combination thereof. The notification device may be coupled to a network system, either wired or wirelessly, to receive on-site data. Smart notification devices, including without limitation Google Glass and Microsoft Hololens, are wearable technologies that facilitate display of augmented reality (AR) environments. A notification device may display hands-free viewing of data pertaining to equipment at the well site. For example, in one or more embodiments, a wireless AR-enabled notification device may enable operators to monitor on-site conditions when away from workstations in control rooms and stand areas by displaying on-site data in an AR environment over the user's field of vision.

Historically, a user or operator may be in close proximity to sensors or equipment generating data, but may not be able to access the data while away from a control stand. The present disclosure enables a user or operator to continue to access data (for example, in an AR environment) when away from a control stand such that the user may modify the operations of equipment and receive rapid feedback regarding those modifications. The present disclosure contemplates audio-visual devices as notification devices that may not be wearable, but may be portable, such that a user might move within and without a sub-site with an audio-visual device that is not necessarily wearable due to size, weight, or other constraints.

Notification devices, like smart phones, may run one or more applications and perform a variety of functions based on said applications. For example, an application may be configured to provide notifications, including without limitation communications such as audio communications and visual communications, upon receipt of on-site data. In one or more embodiments, an application may be configured to display on-site data directly to the user, for example, in an AR environment. In other embodiments, an application may be configured to display a simple status indication based on on-site data. For example, a status notification may comprise one or more of a visual indication, for example, display of a colored or blinking light, an audio notification, for example, a tone or warning message, and a haptic notification, for example, a vibration or series of vibrations.

As indicated herein, in one or more embodiments, the notification device may enable on-site operators to leave workstations to interact with equipment on-site while continuing to receive on-site data, including without limitation volumes, levels, weights, temperatures, pressures, rates, densities, speeds, positions, torques, viscosities, conductivities, pH levels, valve positions, engine and motor information, and other data associated with any one or more systems, equipment, and devices at the well site or remote from the well site. The on-site data may be presented as one or more audio notifications, visual notifications, haptic notifications, or any combination thereof. In response, an on-site operator may be prompted to modify certain on-site operations, for example, to improve the efficiency and safety of one or more on-site operations. As the on-site operator makes modifications, the data repository may be updated with new or current on-site data and the new or current on-site data may be transmitted to the notification device. The notification device may update existing notifications or provide new notifications that reflect the current on-site data. Accordingly, on-site operators may optimize on-site operations efficiency and safety by receiving feedback via the notification device while directly interacting with on-site equipment 108 and systems. For example, a sudden change in a rate or pressure may affect on-site equipment, which may affect the on-site operations. An operator receiving a notification regarding that change might modify one or more pumps or parameters to improve one or more of operations efficiency and safety.

As noted herein, in one or more embodiments, notifications may be real-time notifications. Real-time notification may be particularly beneficial if a notification device is configured to provide warning notifications. For example, in one or more embodiments, a notification device for use in association with hazardous applications may be configured to provide health and safety environment (HSE) notifications including without limitation notification of electrical hazards, high pressure hazards, and notification of conditions conducive to an explosion, as well as the potential time and location of such risks. In response to a warning notification, a user wearing the notification device might receive a notification and might engage safety systems, might disable systems producing the HSE risks, or might simply evacuate the area involving HSE risks.

In one or more embodiments, a notification device may be configured to provide a maintenance notification, indicating that certain on-site equipment needs repair or other maintenance. In response to a maintenance notification, a user wearing the notification device might initiate maintenance, take note of maintenance needs, or otherwise modify equipment to improve performance or longevity of equipment.

The notification device may be configured to prioritize certain visual or audio notifications based on a data priority. Prioritized notifications may override display of other notifications. For example, maintenance notifications might take a lower data priority than warning notifications, because an on-site operator may need to immediately respond to a warning condition while equipment repairs may be queued for subsequent handling. Accordingly, if the notification device is currently displaying one or more maintenance notifications, the notification device may hide maintenance notifications and display one or more warning notifications instead. Further, if the notification device receives multiple notifications with different priorities in close succession, the notification device 110, potentially in conjunction with one or more other devices including without limitation control computers 102, may process the higher priority notification prior to processing the lower priority notification such that the higher priority notification is produced prior to, queued before, or displayed over the lower priority notification. In one or more embodiments, the notification device may comprise a communication system. The communication system may be coupled to the network system providing on-site data to the notification device so the notification device may transmit data to local resources 106, global resources 116 including data repository 120, or to other notification devices 110 coupled to the network. For example, the communication system may enable capture of one or more of audio and video data, and it may be beneficial for the notification device 110 to transmit the audio and video data captured to the data repository 120. In one or more embodiments, the communication system may also enable communication between two or on-site operators wearing notification devices 110.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. It should be understood that various changes, substitutions and alterations can be made herein without departing from the spirit and scope of the disclosure as defined by the claims. Further more, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are each defined herein to mean one or more than one of the element that it introduces.

What is claimed is:

1. A well site notification system comprising:
one or more sensors for collecting data associated with one or more well site equipment,
wherein the one or more sensors is at a first location;
a notification device at a second location;
a network system coupled to the one or more sensors and the notification device; and
a data repository, wherein the data repository stores the data,
wherein the notification device receives the data and provides one or more notifications based, at least in part, on the data, and
wherein one or more operations of the one or more well site equipment is modified based, at least in part, on the first one or more notifications.

2. The well site notification system of claim 1, wherein the notification device further comprises one or more of a display system, an audio system, a haptic feedback system, and a communication system.

3. The well site notification system of claim 2, wherein the one or more notifications is one or more of one or more audio notifications, one or more visual notifications, and one or more haptic notifications.

4. The well site notification system of claim 1, wherein the notification device provides the one or more notifications in at least one of one or more augmented reality environments and one or more virtual reality environments.

5. The well site notification system of claim 1, wherein the notification device is at least one of a wearable device and a portable device.

6. The well site notification system of claim 1, wherein the data is collected in real-time and wherein the one or more notifications is provided in real-time.

7. The well site notification system of claim 1, wherein the notification device further comprises a processor, and wherein the processor executes one or more instructions that at least one of requests the data from the data repository, receives the data from the data repository, and modifies the data to produce the notification based, at least in part, on the data from the data repository.

8. The well site notification system of claim 1, wherein the first location is in close proximity to the second location.

9. A method comprising:
collecting a first data associated with one or more well site equipment;
storing the first data in a data repository;
receiving the first data from the data repository;
transmitting the first data to a notification device;
producing a first notification using the notification device based, at least in part, on the first data, and
modifying one or more well site operations corresponding to the one or more well site equipment based, at least in part, on the notification produced using the notification device.

10. The method of claim 9, wherein the first notification is one or more of a status notification, a warning notification, and a maintenance notification.

11. The method of claim 9, wherein the first notification comprises one or more of one or more audio notifications, one or more visual notifications, and one or more haptic notifications.

12. The method of claim 9, further comprising requesting the first data from the data repository.

13. The method of claim 9, further comprising periodically requesting the first data from the data repository and periodically updating the first notification.

14. The method of claim 9, further comprising producing a second notification based, at least in part, on the first data, wherein the second notification eliminates the first notification.

15. The method of claim 9, wherein transmitting the first data to the notification device further comprises wirelessly transmitting the data.

16. The method of claim 9, wherein the first data is real-time data and wherein the first notification is produced in real-time.

17. The method of claim 9, wherein modifying one or more well site operations further comprises one or more of modifying cementing operations, modifying drilling operations, modifying mud system parameters, modifying bulk material system parameters, mitigating well site operations risks, and modifying well site equipment for repairs and improvements.

18. The method of claim 9, further comprising transmitting a second data to the notification device; and producing a second notification using the notification device based, at least in part, on the second data, wherein the second data corresponds to the first data.

19. A well site notification system comprising:
one or more sensors for collecting data associated with one or more well site equipment,
wherein the one or more sensors is at a first location;
a notification device at a second location;
a network system coupled to the one or more sensors and the notification device; and
a data repository, wherein the data repository stores the data,
wherein the notification device receives the data and provides one or more notifications based, at least in part, on the data and based, at least in part, on at least one of one or more configuration settings and one or more access controls, and
wherein one or more operations of the one or more well site equipment is modified based, at least in part, on the first one or more notifications.

20. The well site notification system of claim 18, wherein the notification device further comprises one or more of a display system, an audio system, a haptic feedback system, and a communication system.
